(19) United States
(12) Patent Application Publication
(10) Pub. No.: US 2007/0078683 A1
(43) Pub. Date: Apr. 5, 2007

(54) Method and apparatus for transferring medical treatment

(76) Inventors: Liliana Grajales, Bloomingdale, IL (US); Gerald J. Gutowski, Glenview, IL (US)

Correspondence Address: MOTOROLA INC, 600 NORTH US HIGHWAY 45, ROOM AS437, LIBERTYVILLE, IL, 60048-5343, US

(21) Appl. No.: 11/241,150

(22) Filed: Sep. 30, 2005

(51) Int. Cl. G06F 19/00; G06Q 40/00

(52) U.S. Cl. 705/3; 705/44

(57) ABSTRACT

A method and apparatus for securely and controllably transferring medical information is provided. An electronic device, like a portable computer, personal digital assistant or intelligent medical monitoring device, is configured to communicate with a healthcare provider's server. The device receives both an authorization code and a medical treatment description from the health care provider. The authorization code permits the user to both view and make a single transfer of the medical treatment description to a medical treatment provider. The authorization code may be as simple as a security PIN, or it may be a digital right that enables software to be accessible to a user within the device. The device is then configured to either print a single copy or electronically upload the medical treatment description to the medical treatment provider. When printed, the medical treatment description may include a unique watermark or scanable barcode to verify authenticity. In one embodiment, a feedback communication may be established between the medical treatment provider and the healthcare provider, thereby providing notification of medical treatment description fulfillment.

### BACKGROUND

1. Technical Field

This invention relates generally to a method and apparatus for securely transferring medical records, and more specifically to a method and portable electronic device for securely, electronically transferring a medical treatment description, like a prescription for example, to a patient for transfer.

2. Background Art

Technology is advancing at a staggering rate. For example, mobile telephones, once a luxury for the wealthy, now appear everywhere. While telegrams were once couriered about to keep people in contact with others, today mobile phones, faxes, wireless broadband communications and pagers allow anyone to keep in touch with home or office in the blink of an eye.

While these technological advances are impressive, some tasks are still accomplished by conventional methods. One such task is that of getting a prescription from a healthcare provider and having it filled. Despite the advances in technology, as anyone who has ever been ill can attest, to get a prescription, one must make an appointment with a healthcare provider, make a trip, wait in the waiting room, see the healthcare provider, have the healthcare provider write the prescription on a piece of paper, take care not to lose the paper, make a trip to a treatment provider like a pharmacy, and then have the prescription filled. The process is both time consuming and cumbersome. The process is more time consuming for people who take medication on an ongoing basis, for example people who take blood pressure, diabetes or cholesterol lowering medications. One reason for the continued use of the paper prescription method is security. In using a paper prescription, the medical treatment provider is able to see the signature of the healthcare provider, thereby ensuring the document's authenticity.

There have been attempts to overcome this cumbersome process, while maintaining security, in the past. One such technological solution is to have the healthcare provider call the medical treatment provider directly. A telephone call might obviate the need for paper. The problem with this solution is that it only works during business hours, when both the healthcare provider and medical treatment provider are able to talk with each other. Should a patient need this paperless transaction after hours, he is out of luck.

A second attempt is that of using a computer server residing with the healthcare provider to communicate with a computer server residing with the medical treatment provider. Rather than a patient carrying a paper prescription, a medical services provider, like a pharmacist for example, may have his computer directly contact the doctor's computer and electronically transfer the prescription.

The problems with this solution are three-fold: First, both servers have to be up, running, and have the extra capacity to communicate. Should one server be down, the patient is out of luck. Next, the patient has no control over the prescription. He is relying on others to safely transfer the prescription. Should his treatment be time sensitive, and should one of the other parties fail in the transfer, he is out of luck. Finally, this system is dependent upon the medical service provider being both technologically advanced and technologically compatible with the healthcare provider. Should the medical treatment provider not have the necessary equipment, or should the medical treatment provider's equipment not be compatible with that of the healthcare provider, the patient is again out of luck. When the patient is out of luck, he is left to wander the streets looking for a suitable alternative for medical treatment.

There is therefore a need for an improved method and apparatus to securely transfer medical treatment information.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a system for securely transferring medical treatment information in accordance with the invention.

FIG. 2 illustrates one embodiment of a device for securely transferring medical treatment information in accordance with the invention.

FIG. 3 illustrates one embodiment of a method for securely transferring medical treatment information in accordance with the invention.

FIG. 4 illustrates another embodiment of a method for securely transferring medical treatment information in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to securely transferring medical treatment information from, for example, a healthcare provider to a medical treatment provider. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions relating to securely transferring medical treatment information from a healthcare provider to a treatment provider. The non-processor circuits may include, but are not limited to, a radio receiver, a radio transmitter, signal drivers, clock circuits, power source circuits, and user input devices. As such, these functions may be interpreted as steps of a method to perform a secure transfer of medical treatment information. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

A system and method for downloading an electronic medical treatment description, for example a medical prescription, from a patient's medical files into a portable electronic device is provided. In one embodiment, the patient's portable electronic device includes software modules capable of downloading the treatment description from a medical record server. The patient, however, is unable to access, retrieve, view, print or otherwise transfer the prescription until a healthcare provider, like a medical doctor for instance, transfers an authorization code, like digital right for example, to the patient's portable electronic device. The digital right enables the user to access the software modules and view the medical prescription. Software modules in the device prohibit the patient from transferring or printing the prescription more than once.

In another embodiment, the healthcare provider transfers an authorization code to the electronic device, thereby allowing the user to see and make a single transfer of the treatment description. Where the treatment description is printed, it may include watermarks or unique barcodes to ensure that only one copy is redeemed for medication. In another embodiment, a treatment provider, e.g. a pharmacist, therapist, medical technician, doctor, nurse, rehabilitation center, clinical facility or medical laboratory, may establish a communication connection with the healthcare provider when the treatment description is redeemed for a treatment, again ensuring that the patient receives the exact, and not multiple, treatments. When the treatment provider communicates with the healthcare provider, the invention may update the patient's medical files in the healthcare provider's system when the treatment description is transferred.

In another embodiment, the treatment description of the present invention follows the clinical standards codes and regulations, and may include a security code that links a transfer of the treatment description to the healthcare provider's computer server and systems. In the case of a refillable prescription, the healthcare provider's server may track the number of times and frequency at which the treatment descriptions are transferred. In so doing, the healthcare provider is capable of canceling either the authorization code or digital right where there is an appearance of misuse.

In addition to the digital right, the device may be configured with a radio-frequency-identification (RFID) tag for communication with the treatment provider, healthcare provider, or both. When transferring the treatment description, the portable electronic device may include a module allowing the treatment provider to mark the treatment description cancelled once transferred.

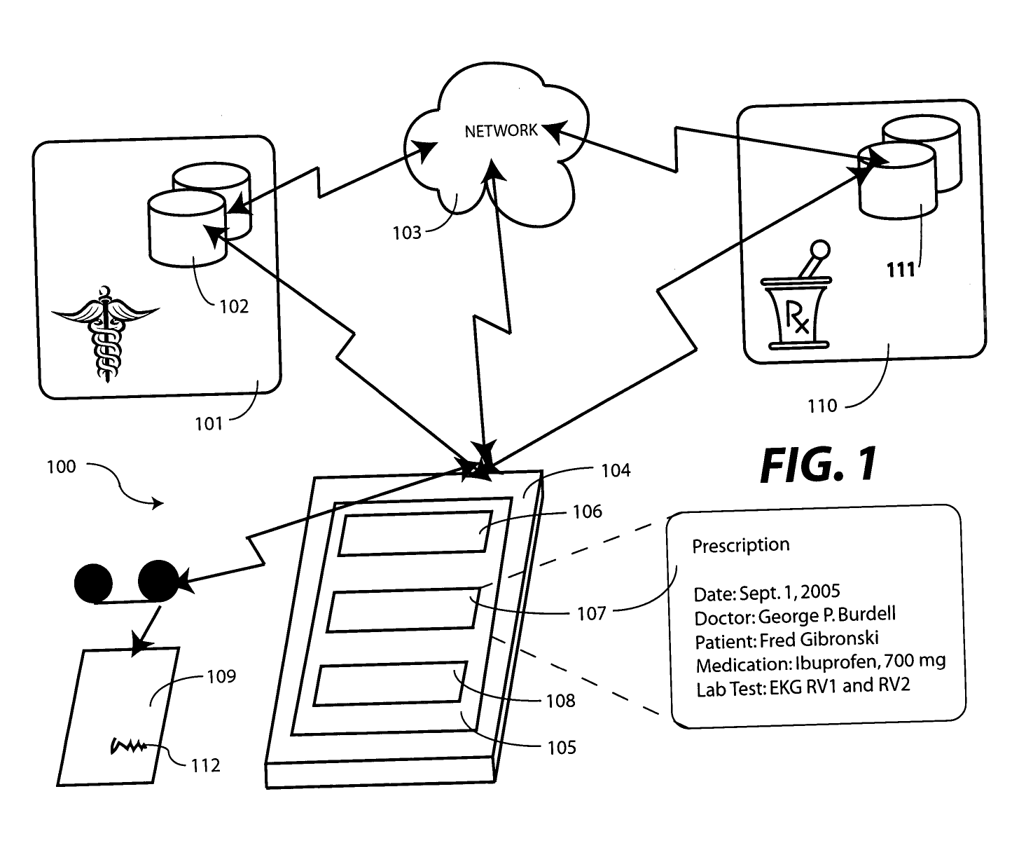

Turning now to FIG. 1, illustrated therein is one embodiment of a system 100 in accordance with the invention. The system 100 includes an electronic device 104 capable of electronically communicating with at least a health care provider 101. The health care provider has an electronic data storage and communication system that includes a server 102 having patient information stored therein. This server 102 includes a medical file server configured to communicate with a portable electronic device 104 of a user. The communication may take place through a conventional infrastructure, like traditional telephone line, or may take place through a data or telecommunication network 103, like a cellular network, wireless network or the Internet.

The medical file server portion of the server 102 stores a treatment description, like a medical prescription for example. The server 102 may also store other medical records, test information, treatment records and the like relating to the patient. This information may be cross-referenced with the treatment description and medical condition of the patient.

The server 102 also includes a healthcare provider's server configured to communicate with the portable electronic device 104. The healthcare provider's server is a portion of the server 102 capable of providing at least an authorization code to the electronic device 104. The electronic device 104 uses the authorization code to enable user access to the treatment description.

Note that the healthcare provider's server and medical file server may simply be different segments of the same server 102 or system. For this reason, both the medical file server and healthcare provider's server will be referred to herein as element 102 in FIG. 1. Note that they could optionally be separate servers, perhaps from different healthcare providers at different locations, for example a generalist and a specialist. The conventional server 102 symbol illustrated in FIG. I is intended to be sufficient in showing the details that are pertinent to understanding the embodiments of the present invention, while not obscuring the disclosure with details that will be readily apparent to those of ordinary skill in the art having the benefit of the description herein.

The difference in the medical file and healthcare provider's portions of the server 102 lies in the fact that a healthcare provider must allow the healthcare provider's server to transmit a secure authorization code to the electronic device, while the medical file server serves as a repository for the patient's medical records and treatment descriptions. This difference will become clearer in the discussion below.

A medical prescription management application operates in connection with the portable electronic device 104. The medical prescription management application, which may be software operational with a processor stored in the electronic device 104, includes a download application that facilitates the downloading of a treatment description or medical prescription from the medical file server 102 upon receipt of the authorization code from the healthcare provider or the healthcare provider's server 102.

The device 104 further includes a local access security application operating in connection with the device 104 that provides the user with view access of the treatment description or medical prescription. The local access security application further prevents the user from making multiple transfers or from printing multiple copies of the treatment description.

In one embodiment, the authorization code that is transferred from the healthcare provider's server 102 is in the form of a digital right that provides the user access to the local access security application. By way of example, the device 104 may include software capable of downloading a treatment description from the medical file server 102. To prevent misuse of the treatment description or medical prescription, however, this software may not be accessible to a user until the digital right has been received from the healthcare provider. As such, the display 105 of the device may remain blank when the user attempts to actuate the local access security application. Once the digital right is received, however, the local access security application provides the user with access to the treatment description. Thus, the display 105 may show one or more treatment descriptions 106-108. Where the treatment description is a medical prescription, e.g. 107, the prescription may include information like the patient's name, the medication to be taken, the healthcare provider's name and associated tests to be run.

In addition to providing the user with access to the treatment description, the local access security application also prevents the user from printing or otherwise transferring more than one copy of the treatment description. For instance, the device 104 is capable of electronically communicating the treatment description 107 to a medical treatment provider 110 and their server 111 when the user so desires. As such, the medical treatment provider's server 111, which is configured to communicate with the electronic device 104, may upload the treatment description 107 upon user authorization.

As an alternative, for example where the medical treatment provider 110 does not have systems compatible with electronic communication, the user may print a single copy 109 of the treatment description when desirable. As a guard against misuse, the one copy 109 of the treatment description may include either a unique barcode or watermark 1 12 attached thereto.

As another safeguard, the medical treatment provider's server 111 may be configured so as to establish a communication channel through the network 103 to the healthcare provider's server 102. When the user transfers or otherwise requests that the treatment description 107 be filled, the medical treatment provider's server 111 may notify the healthcare provider's server 102 that the local access security application has transferred the treatment description 107 from the electronic device 104.

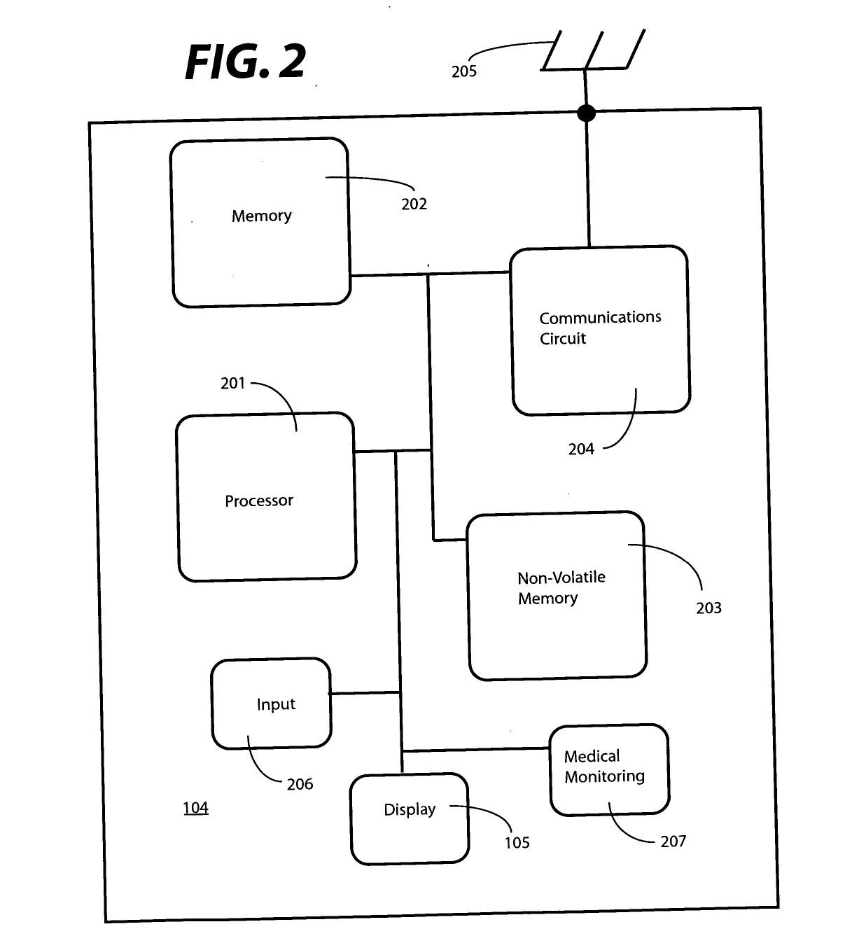

Turning now to FIG. 2, illustrated therein is one embodiment of an electronic device 104 suitable for use with the present invention. The device 104 includes a central processor 201 and memory 202,203 operably coupled to the processor 201. The memory 202,203 may include both volatile 202 and non-volatile 203 memory elements. The memory devices 202,203 may be used for storing software and firmware code instructions for the processor 201.

The device 104 may further include a communications circuit 204 operably coupled to the processor 201 for communicating with a remote server (e.g. 102 and 111 of FIG. 1). The communication circuit 204 may communicate in a variety of ways. For example, it may employ wireless communications through an antenna 205, or it may employ wired communications, perhaps through a universal serial bus (USB) connection. Further, it may employ local area wireless communications, for example Bluetooth communications. It may also employ locally readable communications, like RFID tags.

The device may further include other components, including an input 206 for receiving data from a user, and a display 105 for presenting information to the user. Where the electronic device 104 takes the form of an intelligent medical monitoring device, for example a heart Holter, the device 104 may also include medical monitoring components 207.

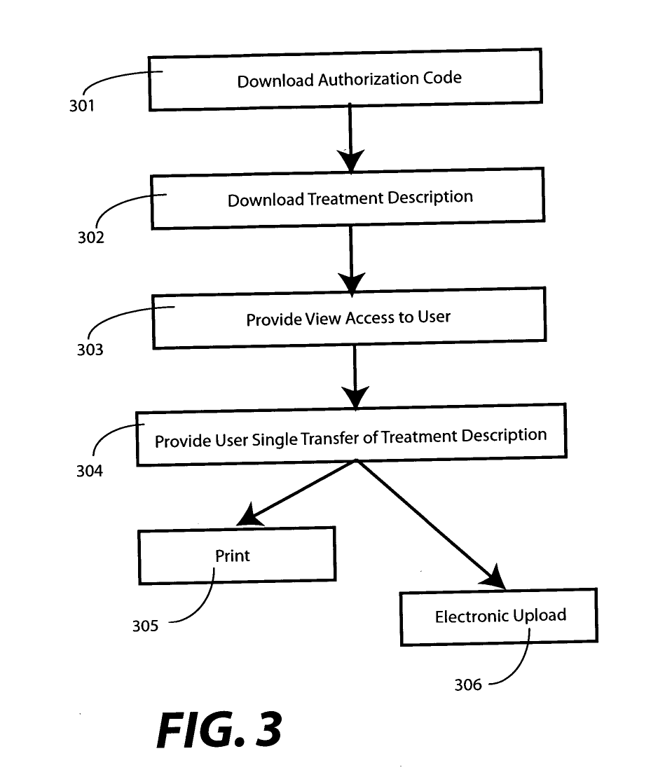

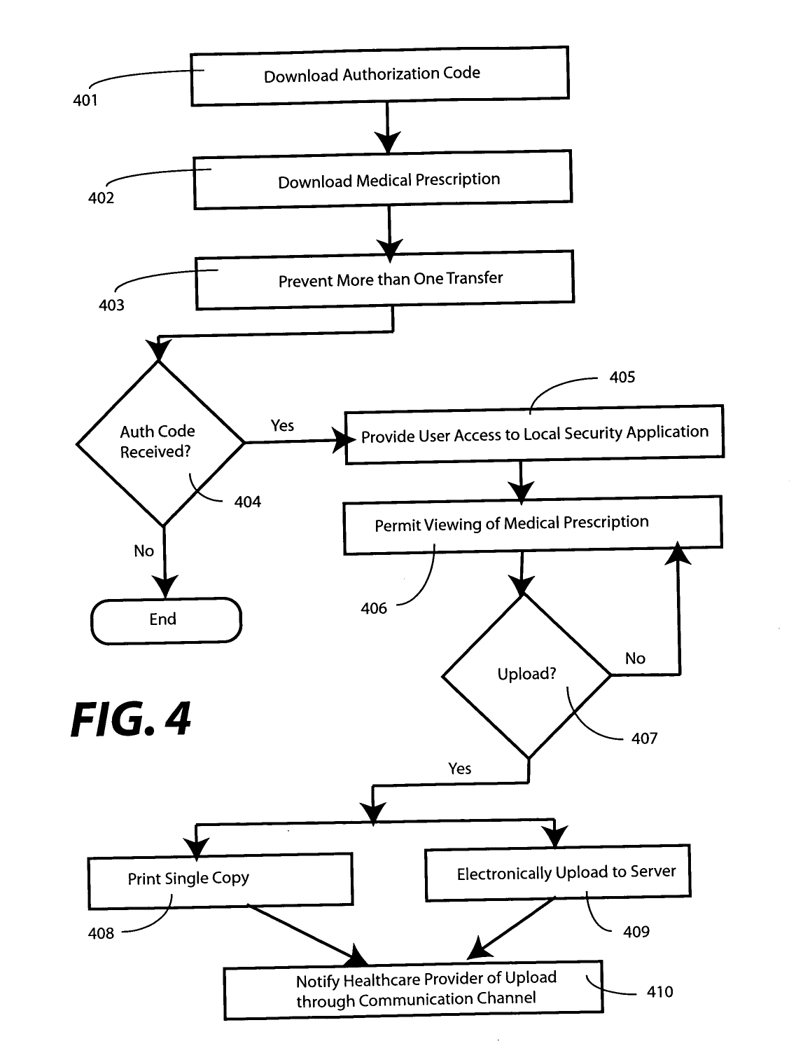

As stated above, the memory components 202,203 may store software modules and commands that include instructions for use by the processor 201. FIGS. 3 and 4 illustrate exemplary methods corresponding to the software applications that are operable in connection with the processor 201 and other components, including the communications circuit 204.

Turning now to FIG. 3, illustrated therein is one method of transferring medical information in accordance with the invention. As stated above, the method may be executed by a software or firmware program operating in conjunction with a processor. It is in this context that FIGS. 3 and 4 will be described.

At step 301, the software operable with a processor downloads an authorization code from the healthcare provider. As noted above, this authorization code may be a security code, like a PIN for example, or it may be a digital right that is used to enable software operating on a device.

At step 302, the software operable with the processor downloads a treatment description from a medical file server that has medical information associated with the user stored therein as previously discussed. Where, for example, the authorization code comprises a PIN or other “electronic key”, the downloading of the medical information may occur after the authorization code has been received. Where the authorization code is a digital right, the medical information may be downloaded before the authorization code.

At step 303, the software operates to provider the user with view access to the medical information, medical prescription or treatment description. This may be via a display, as was discussed with FIG. 1. As also noted above, the software in the device provides the user with only a single transfer of the treatment description. The software thus further prevents more than one transfer of the treatment description from the device.

One example of a suitable transfer is that of printing a single copy of the treatment description. Such a printing is shown in step 305. Where the treatment description is printed, to prevent fraud or other misuse, the treatment description may include a unique watermark or barcode attached thereto.

As an alternative to printing, a user may authorize a medical treatment provider to electronically upload the treatment description. This is shown at step 306. Where the treatment description is uploaded, the user may not be permitted to print, and vice versa.

Turning now to FIG. 4, illustrated therein is another method for transferring medical treatment information in accordance with the invention. Some of the steps are similar to those found in the discussion of FIG. 3, while other steps are different.

As discussed earlier, at step 401, an authorization code is downloaded from a healthcare provider's server into a medical treatment management application operable in connection with a portable electronic device. At step 402, a medical treatment description is downloaded from a medical server having medical information associated with a user stored therein. The medical treatment description is downloaded into the medical treatment management application operating in conjunction with the device. As mentioned earlier, the healthcare provider's server and medical server may be the same.

Shown at step 403, yet operational throughout the method, the medical treatment management application acts to prevent a user from making more than one transfer of the medical treatment description. The medical treatment management application checks to see whether the authorization code, be it a security PIN or digital right, has been received at decision 404. Where it has, the medical treatment management application provides a user access to a local security application at step 405. The local security application, a component of the medical treatment management application, permits the user view access to the medical treatment description at step 406.

The local security application further permits the user a single transfer of the medical treatment description to a treatment provider. The user is optionally permitted to grant an authorization to permit the transfer. Where this authorization is employed, the local security application checks to see if this permission has been granted at decision 407. If it has, the local security application permits the user a single transfer of the medical treatment description to the medical treatment provider in one of a couple of ways.

One option is to permit the user to print a single copy of the medical treatment description at step 408. As noted above, when the single copy is printed, it may include an element selected from the group consisting of unique barcodes and watermarks affixed thereto.

The other option of transferring the medical treatment description is to permit an electronic upload of the medical treatment description by the medical treatment provider, as shown at step 409. This transfer may be made through wireless or wired communications. In one embodiment, the electronic device first establishes a communication link with the medical treatment provider, and then transmits the medical treatment description directly to the medical treatment provider.

When the treatment description is printed, a user may hand deliver it to the medical treatment provider. Where it is electronically uploaded, the medical treatment provider has an electronic record. As a security measure, in one embodiment, the medical treatment provider may communicate the transfer of the medical treatment description to the healthcare provider's server as is shown at step 410. The health care provider may then keep records of treatment description fulfillment in the user's medical files.

Note that the electronic device of the present invention could take many forms. It may be incorporated, for example, into a mobile telephone. It may be a stand alone device, or may be incorporated into a portable computer or personal digital assistant. It will be clear to those of ordinary skill in the art having the benefit of this disclosure, however, that the invention is not so limited. It could equally be incorporated into an intelligent medical monitoring device, for example a heart monitoring Holter. Where the invention is incorporated into such a device, a record of the treatment description may be maintained in memory so that a healthcare provider may cross reference the medical monitoring data with the corresponding prescription or treatment description.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A device capable of storing medical information, comprising:
a. a processor;
b. a memory operably coupled to the processor;
c. a communications circuit operably coupled to the processor and the memory for communicating with at least one remote server; and
d. a software application operable in connection with the processor and the communications circuit, comprising:
i. software operable to download at least an authorization code from a healthcare provider;
ii. software operable to download at least a treatment description from a medical file server having medical information associated with a user stored therein after the at least an authorization code has been downloaded;
iii. software operable to provide the user with view access of the at least a treatment description; and
iv. software operable to provide the user with a single transfer of the at least a treatment description.

2. The device of claim 1, wherein the authorization code comprises a digital right, the digital right enabling the software operable to provide the user with view access of the at least one treatment description.

3. The device of claim 2, wherein the digital right enables the software operable to provide the user with a single transfer of the at least a treatment description, wherein the software operable to provide the user with a single transfer of the at least a treatment description comprises an application permitting the user to print one copy of the at least a treatment description.

4. The device of claim 3, wherein the one copy of the at least a treatment description comprises an element attached thereto, the element selected from the group consisting of unique barcodes and watermarks.

5. The device of claim 2, wherein the digital right enables the software operable to provide the user with a single transfer of the at least a treatment description, wherein the software operable to provide the user with a single transfer of the at least a treatment description comprises an application permitting a medical treatment provider to electronically upload the at least a treatment description.

6. The device of claim 5, wherein the medical treatment provider is permitted to electronically upload the at least a treatment description upon receipt of an upload authorization from the user.

7. A system for transferring at least one medical prescription to a portable electronic device, the system comprising:
a. a medical file server configured to communicate with the portable electronic device and to store the at least one medical prescription;
b. a healthcare provider's server configured to communicate with the portable electronic device and to provide at least an authorization code, the at least an authorization code configured to be used by the electronic device to determine whether to allow access to the at least one medical prescription;
c. a medical prescription management application operating in connection with the portable electronic device, the medical prescription management application comprising a download application, the download application facilitating downloading the at least one medical prescription after receipt of the at least an authorization code; and
d. a local access security application disposed within the portable electronic device, the local access security application providing the user view access to the at least one medical prescription, the local access security application preventing the user from more than once printing or transferring the at least one medical prescription.

8. The system of claim 7, wherein the at least an authorization code comprises a digital right capable of providing the user access to the local access security application.

9. The system of claim 8, wherein the local access security application provides the user upload control over the at least one medical prescription.

10. The system of claim 8, wherein the local access security application comprises a print application permitting the user to print one copy of the at least one medical prescription.

11. The system of claim 10, wherein the one copy of the at least one medical prescription comprises an element selected from the group consisting of unique barcodes and watermarks.

12. The system of claim 7, further comprising a medical treatment provider's server configured to communicate with the portable electronic device and to be capable of uploading the at least one medical prescription upon user authorization.

13. The system of claim 12, further comprising a communication channel between the medical treatment provider's server and the healthcare provider's server, whereby the medical treatment provider's server may notify the healthcare provider's server when the local access security application has transferred the at least one medical prescription from the portable electronic device.

14. A method for transferring medical treatment information, the method comprising the steps of:
a. downloading an authorization code from a healthcare provider's server into a medical treatment management application operable in connection with a portable electronic device;
b. downloading the medical treatment description from a medical server having medical information associated with a user stored therein into the medical treatment management application;
c. providing the user view access to the medical treatment description; and
d. permitting, by way of the medical treatment management application, the user a single transfer of the medical treatment description to a medical treatment provider.

15. The method of claim 14, wherein the authorization code comprises a digital right, wherein the digital right enables the step of permitting the user a single transfer of the medical treatment description to the medical treatment provider.

16. The method of claim 15, wherein the step of permitting the user a single transfer of the medical treatment description to the medical treatment provider comprises permitting the user to print a single copy of the medical treatment description.

17. The method of claim 16, wherein the single copy comprises an element selected from the group consisting of unique barcodes and watermarks.

18. The method of claim 15, wherein the step of permitting the user a single transfer of the medical treatment description comprises permitting an electronic upload of the medical treatment description by the medical treatment provider.

19. The method of claim 18, further comprising the step of communicating the single transfer of the medical treatment description from the medical treatment provider to the healthcare provider's server.

20. The method of claim 15, wherein the step of permitting the user a single transfer of the medical treatment description comprises:
a. establishing a communication link with the medical treatment provider; and
b. transmitting the medical treatment description to the medical treatment provider.
